(19) United States
(12) Patent Application Publication
(10) Pub. No.: US 2009/0235003 A1
(43) Pub. Date: Sep. 17, 2009

(54) MEMORY CONTROL DEVICE AND MEMORY CONTROL METHOD

(76) Inventors: Takaharu Tanaka, Osaka (JP); Tetsuji Mochida, Osaka (JP)

Correspondence Address: MCDERMOTT WILL & EMERY LLP, 600 13TH STREET, NW, WASHINGTON, DC, 20005-3096, US

(21) Appl. No.: 11/916,748

(22) PCT Filed: Dec. 26, 2005
(86) PCT No.: PCT/JP2005/023786

§ 371 Date: Dec. 6, 2007

(30) Foreign Application Priority Data
Jun. 9, 2005 (JP) 2005-169817

(51) Int. Cl. G06F 13/14; G06F 12/00

(52) U.S. Cl. 710/242; 711/105; 711/147; 711/E12.001

(57) ABSTRACT

Access requests issued from access circuits 30, 40 are arbitrated in an arbitration circuit 20 and are accessed to a storage device 10. On the other hand, access requests issued from the access circuits 30, 40 are arbitrated in the arbitration circuit 21 and are accessed to a storage device 11.

### TECHNICAL FIELD

The present invention relates to devices and methods for memory control for performing effective memory access.

### BACKGROUND ART

Recently, house-use LSIs are used in the form of unified memories including a single external memory in many cases in view of system cost down, so that the single memory receives various kinds of memory access requests. Further, with a plurality of functions installed, a higher bandwidth is demanded, needing high-speed memories.

Referring to a DRAM as one example, the operation frequency of the DRAM's memory cells has not been so changed as ever, and therefore, the minimum access size to the DRAM has been increasing more and more when viewed from the user's side. For this reason, though less or no problem is involved in transmitting data having long burst length, the amount of transmitted invalid data increases in transmitting data having short burst length to lower the effective bandwidth.

For example, in medium processing, a problem of lowering the effective bandwidth is involved in motion compensation necessitated for video coding. This problem could have been solved only by using an expensive DRAM that can withstand such lowering of the effective bandwidth (see, for example, Patent Document 1).

### Patent Document 1: Japanese Patent Application Laid Open Publication No. 2000-175201

### SUMMARY OF THE INVENTION

### Problems that the Invention is to Solve

Nevertheless, as described above, when a DRAM exhibiting high performance in data transmission is employed, the amount of transmitted invalid data increases in transferring data having short burst length to lower the effective bandwidth. Further, when an access circuit accessible to a plurality of storage devices accesses one of the storage devices, the access request of the access circuit accessible to the plurality of storage devices is kept waiting if the storage device has already received an access request from another access circuit.

In addition, if a storage device out of the accessible storage devices receives no access request from any other access circuit, the bandwidth of this storage device is wasted by the wait time.

Consider next the case of data transmission, such as data copy or the like among a plurality of storage devices. One of access circuits accesses one of storage devices first, data which is stored in this memory and to which another access circuit is to access is stored into another storage device to which the other access circuit is accessible, and only thereafter, the other access circuit accesses the thus stored data. This data transmission, however, takes much time when processing a large amount of data. Storage devices to which an access circuit is accessible is usually used for another purpose, for example, as local memories or the like for storing data relating to the access circuit, and therefore, an additional memory area for data transmission between the plurality of storage devices must be reserved. If the storage devices cannot perform time sharing or the like, the capacities or the bandwidth of the memories must be increased or another countermeasure should be provided. An increase in memory capacities, memory bandwidths, or the like necessitates similar countermeasures by the number of master storage devices, increasing the circuit area.

Further, provision of an access circuit accessible to a plurality of storage devices complicates an arbitration circuit to thus increase the circuit area and power consumption. A plurality of such access circuits involves the similar problems of which number is equal to the number of the access circuits.

In the case where such an LSI is developed to a low-end field, a single storage device may suffice because the bandwidth request is low. In this case, however, all access circuits must be accessible to the single storage device. Such a configuration increases the circuit area for only development to a low-end field, involving wiring congestion in layout design of an LSI and the like.

The present invention has been made in view of the foregoing and has its object of enhancing an effective bandwidth.

### Means for Solving the Problems

To attain the above object, the present invention provides a memory control device including: at least two storage devices in which data is stored; at least two access means which access a storage device; and an arbitration circuit which arbitrates access requests issued from the respective access means for each of the storage devices.

### EFFECTS OF THE INVENTION

With the above arrangement in accordance with the present invention, the amount of transmitted invalid data out of data having short burst length can be reduced, attaining advantageous effect in enhancing the effective bandwidth. Further, not every access circuit has to be accessible to the plurality of storage devices, leading to advantageous effect in reducing the circuit area.

Further, access to the storage devices in an efficient sequence is enabled to increase the effective bandwidth further in each storage device. Moreover, some of the access circuits needs not to be accessible to the plurality of storage devices, attaining advantageous effects in reducing the circuit area. As well, this is advantageous in reducing the circuit area even when taking development of the LSI into consideration and attains quick activation and advantageous effects in reducing power consumption.

### BRIEF DESCRIPTION OF THE DRAWINGS

FIG. 1 is a block diagram showing a configuration of a memory control device in accordance with Embodiment 1 of the present invention.

FIG. 2 is a block diagram showing a configuration of a conventional memory control device.

FIG. 3 is a block diagram showing a configuration of a memory control device in accordance with Embodiment 2.

FIG. 4 is a block diagram showing a configuration of the memory control device in accordance with Embodiment 2.

FIG. 5 is a block diagram showing another configuration of the memory control device in accordance with Embodiment 2.

FIG. 6 is a block diagram showing a configuration of a memory control device in accordance with Embodiment 3.

FIG. 7 is a block diagram showing an internal configuration of an arbitration circuit in accordance with Embodiment 3.

FIG. 8 is a block diagram showing another internal configuration of the arbitration circuit in accordance with Embodiment 3.

FIG. 9 is a block diagram showing a configuration of a memory control device in accordance with Embodiment 4.

FIG. 10 is a block diagram showing a configuration of a memory control device in accordance with Embodiment 5.

FIG. 11 is a block diagram showing a configuration of a memory control device in accordance with Embodiment 6.

FIG. 12 is a block diagram showing a configuration of a memory control device in accordance with Embodiment 7.

### EXPLANATION OF REFERENCE NUMERALS

10 storage device
11 storage device
20 arbitration circuit
21 arbitration circuit
25 data arbitration circuit
26 data arbitration circuit
30 access circuit
40 access circuit
50 inter-storage-device transfer circuit
60 register
91 register
120 register
121 register
70 primary storage device
71 vacant information managing device
80 arbitration section
90 switching circuit
100 selector
110 selector

### BEST MODE FOR CARRYING OUT THE INVENTION

Embodiments of the present invention will be described below in detail with reference to the accompanying drawings. The following preferred embodiments describe mare essential examples and does not intend to limit the present invention, applicable subjects, and use thereof.

### Embodiment 1

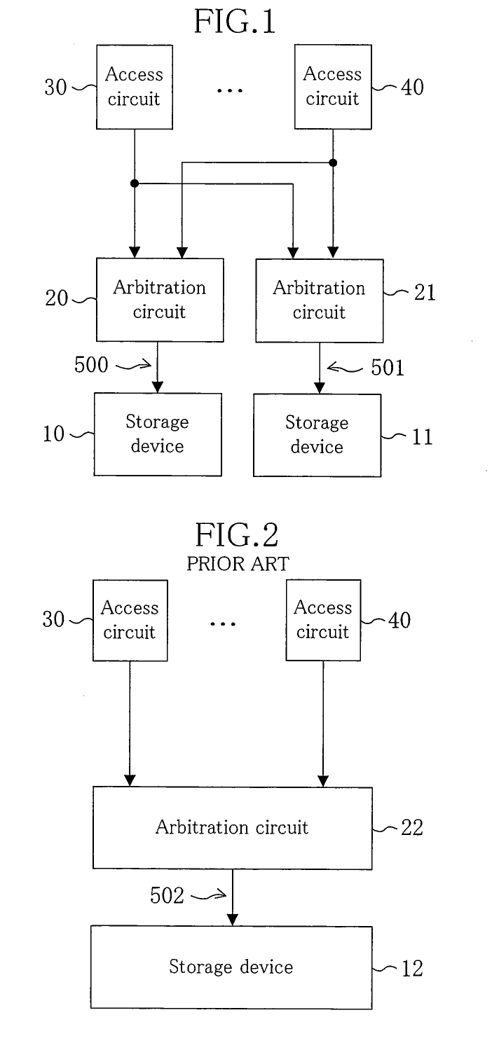

FIG. 1 is a block diagram showing a configuration of a memory control device in accordance with Embodiment 1 of the present invention. As shown in FIG. 1, reference numerals 30 and 40 denote access circuits accessibly connected to a storage device 10 through an arbitration circuit 20 and accessibly connected to a storage device 11 through an arbitration circuit 21.

Though FIG. 1 refers the case using the two access circuits 30, 40, two or more access circuits may be provided. This can be applied to any of the following embodiments as well.

The respective arbitration circuits 20, 21 arbitrate access requests issued from the access circuits 30, 40 to the storage devices 10, 11 for each storage device 10, 11.

Each storage device 10, 11 stores necessary data and reads out data in response to an access request and is, specifically, composed of a DDR2 (Double Data Rate 2).

Suppose herein that the bus width of a data bus 500 between the arbitration circuit 20 and the storage device 10 is set at four bytes while the bus width of a data bus 501 between the arbitration circuit 21 and the storage device 11 is set at four bytes. Accordingly, the minimum access unit is four burst, namely, 16 bytes.

As a comparative example for comparing the performance of the memory control device in accordance with Embodiment 1, a configuration of a conventional memory control device is shown in FIG. 2. In FIG. 2, the access circuits 30, 40 are accessibly connected to a storage device 12 through an arbitrary circuit 22.

Suppose herein that the bus width of a data bus 502 between the arbitration circuit 22 and the storage device 12 is set at eight bytes and a DDR2 is employed as the storage device 12. Accordingly, the minimum access unit is four burst, namely, 32 bytes.

The amount of transferred invalid data will be examined below specifically. When supposing that the access circuits 30, 40 of the memory control circuit shown in FIG. 1 in Embodiment 1 are circuits that perform motion compensation of video decoding processing, the amount of the transmitted invalid data, which the access circuit 30 frequently performing 16-byte access transmits, is zero byte in the case with no page spanning.

On the other hand, the access circuits 30, 40 of the conventional memory control device shown in FIG. 2 involve 16-byte invalid data transmission. This means double enhancement in performance of the memory control device of Embodiment 1 when compared with the conventional memory control device.

Further, when no access is required in the storage device 10 from the two access circuits 30, 40 of the memory control device of Embodiment 1, wait time required for arbitration in the arbitration circuit 20 is reduced in general when viewed from one of the access circuits, which is preferable.

It is noted that though the memory control device of Embodiment 1 employs DRAMs (Dynamic Random Access Memories) as the storage devices 10, 11 but the present invention is not limited thereto and may employ SRAMs (Static Random Access Memories), flash memories, or the like, for example.

The storage devices 10, 11 may be different in kind from each other. For example, the storage device 10 may be a DRAM while the storage device 11 may be a flash memory.

The memory control device of Embodiment 1 uses the two storage devices 10, 11 but may use two or more storage devices. The storage devices 10, 11 may have any bus widths.

The present embodiment refers to the access circuits 30, 40 each accessible to the storage devices 10, 11, but the access circuits 30, 40 may be accessible to only either storage device.

Furthermore, in the case where a circuit performing the operation of the memory control device in Embodiment 1 is composed of an LSI, the access circuits 30, 40 may be provided internally or externally.

### Embodiment 2

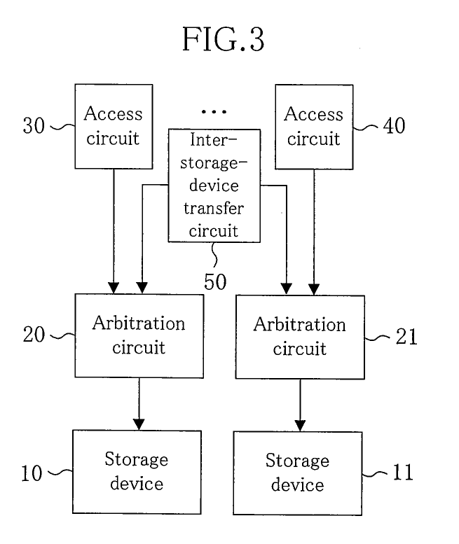

FIG. 3 is a block diagram showing a configuration of a memory control device in accordance with Embodiment 2 of the present invention. Difference from Embodiment 1 lies only in that an inter-storage-device transfer circuit 50 is provided between the arbitration circuits 20, 21, and therefore, the same reference numerals are assigned to the same elements as those in Embodiment 1 for describing only the difference. The same is applied to the following Embodiments 3 to 7.

As shown in FIG. 3, the access circuit 30 is accessibly connected to the storage device 10 through the arbitration circuit 20. As well, the access circuit 40 is accessibly connected to the storage device 11 through the arbitration circuit 21.

Between the two arbitration circuits 21, 21, an inter-storage-device transfer circuit 50 is provided for performing data transmission between the storage devices 10, 11.

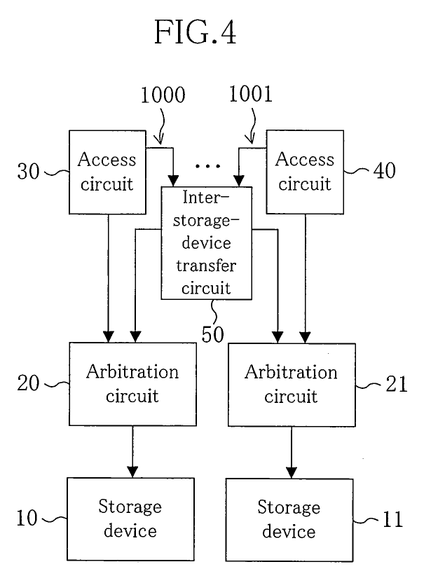

As shown in FIG. 4, in the case where a series of data access from, for example, the access circuit 30 to the storage device 10 in response to an access request is completed and the other access circuit 40 requires the data thereafter, an instruction as a signal 1000 output from the access circuit 30 is provided to the inter-storage-device transfer circuit 50 to allow the inter-storage device transfer circuit 50 to copy the necessary data from the storage device 10 to the storage device 11. After data copy is completed, the access circuit 40 accesses the data previously stored in the storage device 11 for performing necessary processing.

On the other hand, in the case where data in the storage device 11 to which the access circuit 40 accesses is required by the other access circuit 30, the inter-storage-device transfer circuit 50 copies, on the basis of a signal 1001 output from the access circuit 40, the necessary data from the storage device 11 to the storage device 10.

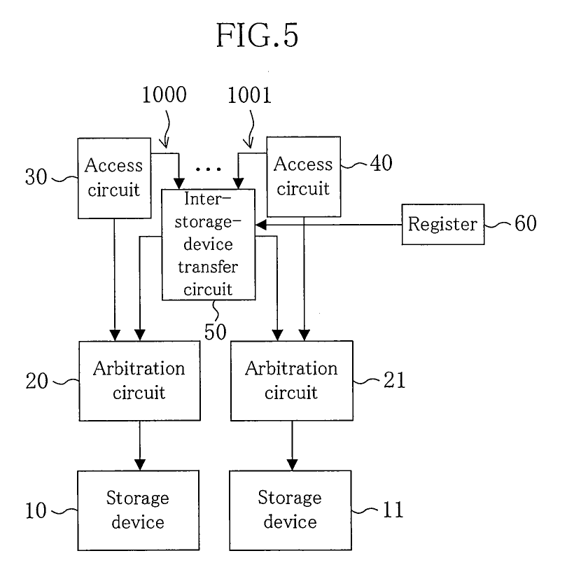

FIG. 5 shows a state in which an externally accessible register 60 is connected to the inter-storage-device transfer circuit 50 of the memory control device shown in FIG. 4. The register 60 stores necessary information, such as an address or the like, and the inter-storage-device transfer circuit 50 is activated on the basis of the information stored in the register 60.

In this way, provision of the inter-storage-device transfer circuit 50 eliminates the need of the access circuits 30, 40 to access the plurality of storage devices 10, 11, leading to advantages in reducing the circuit area and power consumption and attaining data copy between the storage devices.

In the arbitration circuits 20, 21, if data is copied when there is no access, of which real time performance should be guaranteed, from the access circuits 30, 40, data copy using effective vacant bandwidth can be attained with real time performance of each access circuit 30, 40 guaranteed, thereby enhancing the operation efficiency.

The access circuits 30, 40 are accessible to a single storage device 10 or 11 in FIG. 3 to FIG. 5, but access circuits accessible to a plurality of storage devices may be used.

### Embodiment 3

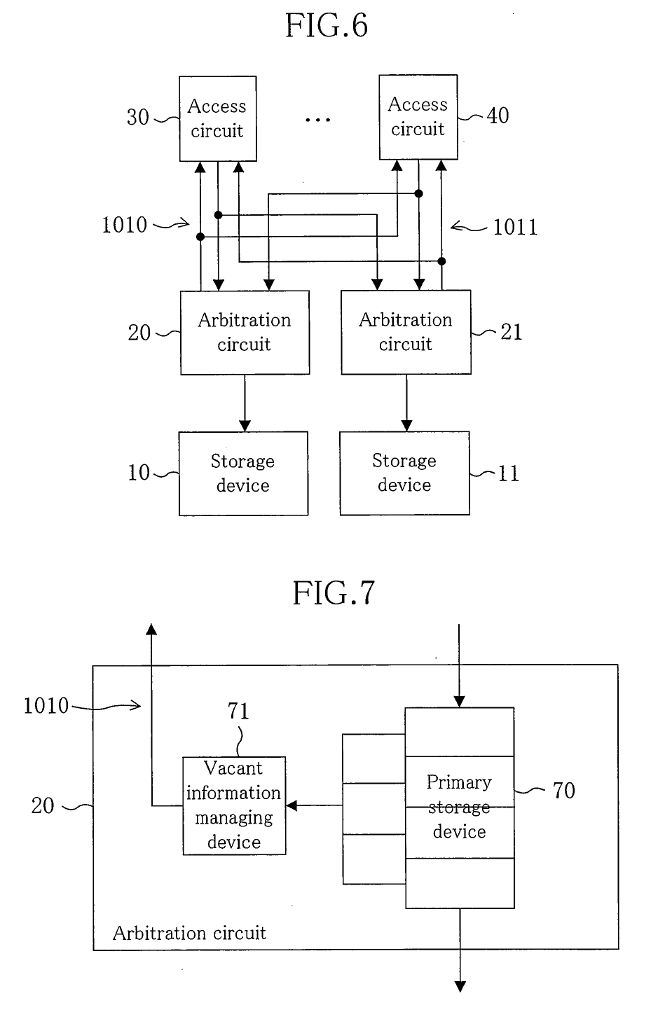

FIG. 6 is a block diagram showing a configuration of a memory control device in accordance with Embodiment 3 of the present invention. As shown in FIG. 6, the access circuits 30, 40 are accessibly connected to the storage devices 10 through the arbitration circuit 20 and accessibly connected to the storage device 11 through the arbitration circuit 21.

The arbitration circuit 20 under the state where the storage device 10 is accessible outputs a signal 1010 indicating the access state to each access circuit 30, 40.

As well, the arbitration circuit 21 under the state where the storage device 11 is accessible outputs a signal 1011 indicating the access state to each access circuit 30, 40.

The access circuits 30, 40 access an optimum storage device on the basis of the respective signals 1010, 1011.

The above control enables immediate receipt of access from, for example, the access circuit 30 that has received the signal 1010, irrespective of the access state of the other access circuit 40.

In other words, if some storage device to which an access circuit accesses is busy because of access from another access circuit, access chance to another accessible storage device having low access frequency may be lost until the busy storage device becomes free. The above control, however, prevents such access change from being lost, which is advantageous.

FIG. 7 is a block diagram showing an internal configuration of the arbitration circuit 20 of the memory control device in accordance with Embodiment 3. As shown in FIG. 7, the arbitration circuit 20 includes a primary storage device 70 for storing access requests from the access circuits 30, 40. This permits the access circuits 30, 40 to perform precedent access issuance by the number of commands that can be stored in the primary storage device 70 without waiting completion of data transmission, leading to an improvement on throughput

To the primary storage section 70, a vacant information managing device 71 is connected which outputs access requests from the access circuits 30, 40 and receives pointer information indicating a data storage state of the primary storage device 70.

The vacant information managing device 71 compares the pointer information with a predetermined set value and informs the access circuit 30 through the signal 1010 about vacant information, as the signal 1010, of the primary storage device 70 according the comparison result.

The predetermined set value to be compared is preferably set with a time period taken into consideration from time when the vacant information is informed to the access circuit 30 to time when a command of an access request issued from the access circuit 30 reaches the arbitration circuit 20.

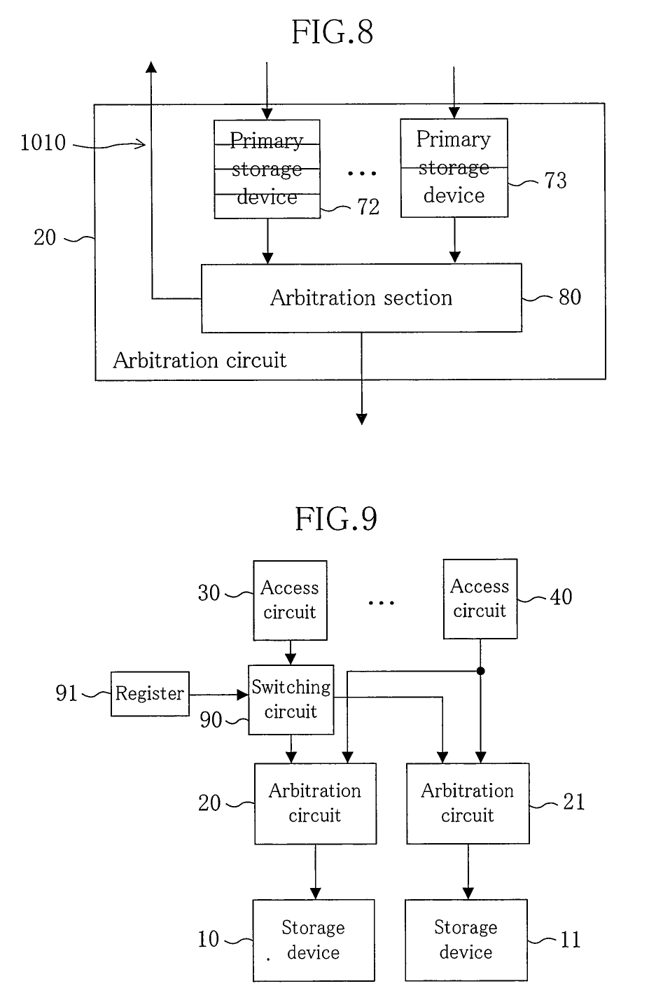

FIG. 8 is a block diagram showing another internal configuration of the arbitration circuit 20 of the memory control device in accordance with Embodiment 3. As shown in FIG. 8, the arbitration circuit 20 includes primary storage devices 72, 73 which correspond to the access circuits 30, 40, respectively. An arbitration section 80 is connected to each output side of the primary storage devices 72, 73.

The arbitration section 80 performs arbitration of access requests from the access circuits 30, 40 and outputs the access request issued from a selected access circuit to the storage device 10.

Further, when the access circuit 30 becomes accessible by arbitration of the arbitration section 80, the arbitration section 80 issues the signal 1010 to inform the access circuit 30 about the accessibility.

For example, the signal 1010 indicating the vacant information may be output with taking into consideration timing that the access circuit 30 becomes necessarily accessible after several cycles, namely, a time period from time when the arbitration section 80 outputs the signal 1010 indicating the vacant information to the access circuit 30 to time when the arbitration section 80 receives an access request issued in the access circuit 30 on the basis of the signal 1010.

The primary storage devices 72, 73 may have any number of stages. The primary storage devices 72, 73 may not necessarily be provide to the access circuits 30, 40, respectively, and the access circuits 30, 40 may share a primary storage device.

### Embodiment 4

FIG. 9 is a block diagram showing a configuration of a memory control device in accordance with Embodiment 4 of the present invention. As shown in FIG. 9, the access circuit 30 is connected to the arbitration circuits 20, 21 through a switching circuit 90. The arbitration circuit 20 is connected to the storage device 10 while the arbitration circuit 21 is connected to the storage device 11. With this configuration, the access circuit 30 is accessible to the storage devices 10, 11 through the arbitration circuits 20, 21.

The access circuit 40 is accessibly connected to the storage device 10 through the arbitration circuit 20 and is accessibly connected to the storage device 11 through the arbitration circuit 21.

The switching circuit 90 switches an access target of the access circuit 30 on the basis of a set value of a register 91, which will be described later, and specifically, switches between the storage devices 10, 11 to be accessed.

To the switching circuit 90, the register 91, which is externally accessible, is connected. The register 91 stores information indicating to which storage device an access request is to be accessed. Value setting of the register 91 changes the access target between the storage devices 10, 11.

The above configuration leads to advantages in reducing the circuit area and power consumption in the memory control device. Specifically, though the access circuit 30 accessible to both the storage devices 10, 11, will increase the circuit area and power consumption in general, application of the present invention to an access circuit which requires access only to the storage device 10, for example, in a given application leads to advantages in reducing the circuit area and power consumption.

### Embodiment 5

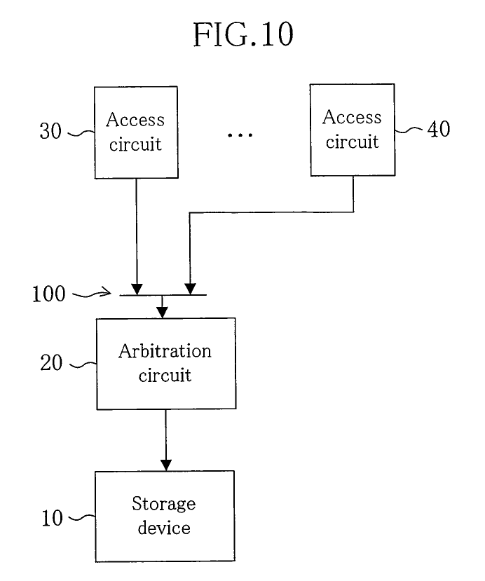

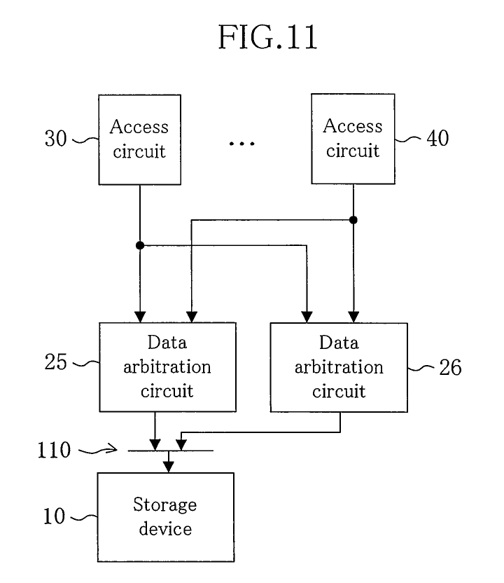

FIG. 10 is a block diagram showing a configuration of a memory control device in accordance with Embodiment 5 of the present invention. As shown in FIG. 10, the access circuits 30, 40 are connected to the arbitration circuit 20 through a selector 100. The arbitration circuit 20 is connected to the storage device 10, and accordingly, the access circuits 30, 40 are accessibly connected to the storage device 10 through the arbitration circuit 20.

The selector 100 outputs only one of access requests from the access circuits 30, 40 selectively to the storage device 10 through the arbitration circuit 20.

This configuration eliminates the need to provide a plurality of storage devices, and can be applied directly to the case, for example, where the same LSI is developed to a low-end field having low bandwidth request. As a result, wiring congestion in LSI design can be obviated with an increase in circuit area suppressed.

### Embodiment 6

FIG. 11 is a diagram showing a configuration of a memory control device in accordance with Embodiment 6 of the present invention. As shown in FIG. 11, the access circuits 30, 40 are connected to each of data arbitration circuits 25, 26. The data arbitration circuits 25, 26 are connected to the storage device 10 through a selector 110. The selector 110 outputs only one of data output from the data arbitration circuits 25, 26 selectively to the storage device 10.

With the configuration, in which an output of a data arbitration circuit is selected for the storage device, the circuit area can be reduced and wiring congestion in layout design can be obviated.

Specifically, in the case where there are many access circuits, input wirings of the selector 110 increases to influence the circuit scale and to invite wiring congestion in layout design. Nevertheless, the above configuration of the memory control device of Embodiment 6 leads to advantages in solving this problem.

Further, the circuit source of the data arbitration circuits 25, 26 of the memory control device in Embodiment 6 is equivalent to those of the memory control device in Embodiment 1 even though no such high bandwidth request is demanded. Hence, the performance is further improved.

### Embodiment 7

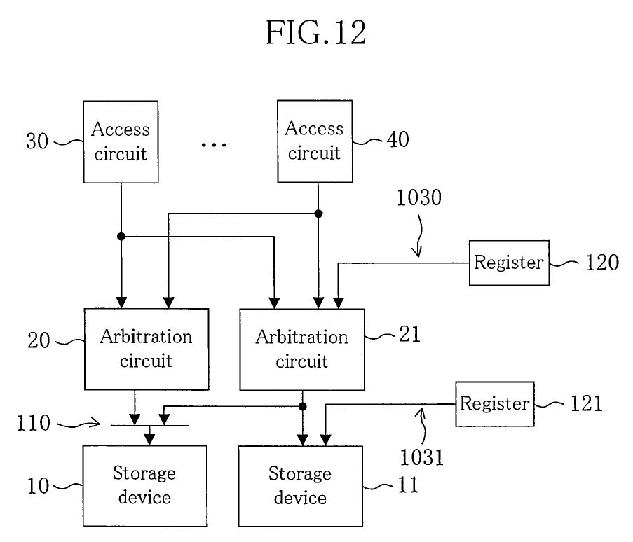

FIG. 12 is a block diagram showing a configuration of a memory control device in accordance with Embodiment 7 of the present invention. As shown in FIG. 12, the access circuits 30, 40 are connected to each of the arbitration circuits 20, 21.

The arbitration circuit 20 is connected to the storage device 10 through the selector 110. The arbitration circuit 21 is connected to the storage device 11 and is connected to the storage device 10 through the selector 110.

To the arbitration circuit 21, a register 120 is connected which outputs to the arbitration circuit 21 a signal 1030 for controlling clock oscillation or stop.

Further, a register 121 is connected to the storage device 11. In the case, for example, where the storage device 11 is a DRAM, the register 121 outputs to the storage device 11 a signal 1031 for controlling power down or self-refresh mode activation or stop.

With the above configuration, when values of the registers 120, 121 are set in a standby mode in which almost all equipment's functions are stopped, the arbitration circuit 21 can be set in a clock stop state while the storage device 11 can be set in a power down state or in the self-refresh mode, thereby suppressing power dissipation.

On the other hand, the arbitration circuit 20 and the storage device 10 are in operation. If an instruction or data of a microcomputer or the like necessary for system recovery is stored in the storage device 10, it is unnecessary to develop the instruction or the data of the microcomputer to the storage device 10 again at recovery from the standby mode, attaining quick activation of the equipment.

### INDUSTRIAL APPLICABILITY

As described above, the present invention attains highly practical effects that the effective bandwidth can be enhanced and is therefore much useful and highly applicable to industries. For example, the present invention can be applied to a network terminal reproducing a compressed and coded stream, a DVD recorder/player, a digital television set, a PDA, a mobile phone, a personal computer, and the like.

1. A memory control device comprising:
at least two storage devices in which data is stored;
at least two access means which access the storage devices; and
an arbitration circuit which arbitrates access requests issued from the respective access means for each of the storage devices.

2. The memory control device of claim 1, further comprising:
a transfer circuit which transfers data stored in the storage devices between the storage devices.

3. The memory control device of claim 2,
wherein the transfer circuit performs data transfer on the basis of control signals output from the respective access means.

4. The memory control device of claim 2, further comprising:
an externally accessible register connected to the transfer circuit,
wherein the transfer circuit performs data transfer on the basis of a set value of the register.

5. The memory control device of claim 2,
wherein the transfer circuit performs data transfer only when no access request for executing a predetermined processing to be executed within a predetermined time period from the respective access means is present.

6. The memory control device of claim 1,
wherein at least one of the plurality of access means is accessible to the plurality of storage devices,
the arbitration circuit outputs to the one access means receipt information indicating a state that an access request issued from the one access means is receivable, and
the one access means determines a sequence of access request issuance on the basis of the receipt information.

7. The memory control device of claim 6,
wherein the arbitration circuit includes a storage circuit which stores a plurality of access requests issued from the respective access means, and
the receipt information is a vacant information indicating a data storing state of a corresponding storage circuit.

8. The memory control device of claim 6,
the receipt information is arbitration information indicating a state that an access request from the one access means is receivable as a result of arbitration by a corresponding arbitration circuit.

9. The memory control device of claim 1, further comprising:
a switching circuit which selectively switches an access target of one of the access means; and
an externally accessible register connected to the switching circuit,
wherein the switching circuit selectively switches, on the basis of a set value of the register, the access target to a storage device to which the one access means is to access.

10. The memory control device of claim 1,
wherein at least one of the plurality of storage devices is accessible from all the access means.

11. The memory control device of claim 10,
wherein the arbitration circuit has a plurality of data arbitrating functions of arbitrating data for each storage device, and
the memory control device further comprising:
a selector which selectively outputs to a storage device one of data arbitration results obtained by arbitration in the plurality of arbitration circuits.

12. The memory control device of claim 10, further comprising:
an externally accessible register connected to the arbitration circuit,
wherein the arbitration circuit controls clock oscillation or stop on the basis of a set value of the register, and
the storage device accessible from all the access means stores an instruction and data necessary for system standby and recovery.

13. The memory control device of claim 1,
wherein each of the plurality of storage devices is composed of a DRAM.

14. A memory control method comprising the steps of:
an accessing step of issuing at least two access requests for allowing them to access storage devices in which data is stored; and
an arbitration step of arbitrating the at least two access requests for each storage device.
